(19) United States
(12) Patent Application Publication
(10) Pub. No.: US 2003/0169235 A1
(43) Pub. Date: Sep. 11, 2003

(54) Three dimensional track ball systems

(76) Inventors: Mikkel Hartmann Gron, Soborg (DK); Oskar Myhre Broberg, Hellerup (DK); Jesper Bruun Jensen, Copenhagen (DK)

Correspondence Address: Klein, O'Neill & Singh, 2 Park Plaza, Ste. 510, Irvine, CA, 92614, US

(21) Appl. No.: 10/207,373

(22) Filed: Jul. 29, 2002

Related U.S. Application Data
(63) Continuation-in-part of application No. PCT/DK02/00144, filed on Mar. 7, 2002.

(30) Foreign Application Priority Data
Mar. 13, 2002 (DK) PA 2002 00386
Apr. 17, 2002 (DK) PA 2002 00565

(51) Int. Cl. G09G 5/08

(52) U.S. Cl. 345/167

(57) ABSTRACT

A three dimensional (3D) track ball system includes a housing having top wall with a circular aperture. A track ball is rotatably mounted in the housing so as to protrude through the aperture. In a preferred embodiment, three supporting elements in the housing rotatably support the track ball. The supporting balls are mounted and journalled in positions in which their respective centers are located in a plane that is parallel with the top wall of the housing, and define an equilateral triangle that is coaxially aligned with the aperture. The centers of the supporting balls are located relative to the center of the track ball so as to define an orthogonal coordinate system, including three orthogonal coordinate axes. The system further includes a motion detection system having three motion detectors, preferably optical detectors, for detecting the motion of each supporting ball along a respective axis of the orthogonal coordinate system, and for generating signals representing the motion of the supporting balls along their respective coordinate axes.

### CROSS-REFERENCE TO RELATED APPLICATION

This application is a Continuation-in-Part of co-pending International Application No. PCT/DK02/00144; filed Mar. 7, 2002.

### FEDERALLY SPONSORED RESEARCH OR DEVELOPMENT

Not Applicable

### FIELD OF THE INVENTION

The present invention relates generally to the field of track balls. More specifically, the present invention relates to three dimensional (3D) track ball systems for use in connection with a computer such as a personnel computer (PC) or any other computer system or similar apparatus or device.

### BACKGROUND OF THE INVENTION

In a computer system, a central processing unit (CPU) or main frame is typically connected to a keyboard, a display unit or screen, and a mouse. The mouse is used for moving a cursor or any other element represented on the screen from one point on the screen to another point on the screen. The mouse might include a housing having a support surface and a track ball positioned within the housing. To move the cursor, the mouse is moved on the support surface causing the track ball to rotate. The rotation of the track ball is detected by a plurality of detectors, which convert the motion or rotation of the track ball into a two dimensional (2D) area represented by the screen. Other types of mouse devices have also been used to move the cursor in a 2D area.

In elaborate computer aided design (CAD)/computer aided manufacturing (CAM) systems, in particular three dimensional (3D) CAD/CAM systems, a need for the movement of the cursor in three dimensions exists. A number of patent publications exist that describe 3D track balls or 3D mouse structures. For example, 3D mouse structures are described in the following patents and patent publications: U.S. Pat. Nos. 4,493,992; 5,561,445; 5,751,275; 5,854,623; 5,774,113; 5,019,809; 5,784,052; 5,914,703; 5,963,197; 5,999,165; 6,164,808; and EP 0 729 112. Furthermore, within the field of track balls, the use of optical sensors is described in, e.g., EP 1 182 606 and U.S. Pat. No. 6,344,643 for the detection of the motion of the track ball. The disclosures of the above patents and patent publications are incorporated by reference herein.

The need for 3D track balls is still growing in the field of PC entertainment, in particular PC games. For example, the more advanced and more elaborate PC games currently available and presently being developed call for 3D track balls or 3D mouse structures. Although the general principle of detecting the motion of a rotating ball using at least three detectors in a 3D simulating display system has proven to be useful, the technique needs certain improvements and refinements to achieve a more accurate, precise, and reliable positioning in the 3D representing display system. Hence, the prior art 3D track balls, in spite of their advantages as compared to conventional 2D track balls, suffer from certain limitations in accuracy, in particular the difficulty in separating the detection of the motion of the track ball in the three dimensions X, Y and Z.

Furthermore, conventional 2D and 3D track balls are not entirely satisfactory, from a user's point of view, because the track balls are too small in size. The small size reduces the accuracy of the conversion of the motion of the track ball in the three dimensions and increases the overall friction of the track ball and mouse structure. Also, conventional 3D track balls are subjected to problems imposed by the presence of dust, dirt, and moisture on the track ball, which is manipulated by the user's fingers as the user operates the track ball. In other words, the track ball, through the operation of the user, is contaminated with dust, dirt, and moisture transferred from the fingers of the user to the track ball. Such contamination may severely degrade the overall detection of the motion of the 3D track ball, and, in some instances, may cause malfunctioning of the 3D track ball.

### SUMMARY OF THE INVENTION

An object of the present invention is to provide a 3D track ball system in which the drawbacks and limitations of the prior art systems are eliminated. In particular, the present invention provides an improved 3D track ball system in which the accuracy of detection of the motion of the track ball representing the 3D motion is optimized as compared to prior art 3D track ball systems.

A further object of the present invention is to provide a 3D track ball system in which the cross talk between the detection of the motion of the track ball in the 3D representing system is substantially eliminated. The present invention ensures that the detection of motion of the track ball representing the motion in one of the dimensions of the 3D display system does not influence the detection of motion along the other two dimensions of the track ball in 3D display systems.

An advantage of the present invention is that the 3D track ball system allows, due to its electrical and mechanical structure, an easily and highly accurate positioning in the 3D display system in an easily operable and low friction track ball system. Another advantage of the present invention is that the motion detection system employed in the 3D track ball system is substantially insensitive to the effects of dust, dirt, moisture, and other contaminants and debris that may be unintentionally transferred to and present on the surface of the track ball.

One embodiment of the present invention includes a 3D track ball having a structure in which the journalling of the track ball is sensed as an almost frictionless journalling or a journalling exhibiting an extremely low friction, allowing the user to easily operate and manipulate the track ball without the necessity of using excessive force for moving and positioning the track ball in its intended position, and providing accurate positioning in the 3D display system.

One embodiment of the present invention includes a 3D track ball system comprising:

i) a housing defining a bottom wall and a top wall, the top wall being in spaced apart relationship above the bottom wall and defining therebetween an inner space of the housing, a substantially circular aperture being provided in the top wall;

ii) a track ball rotatably mounted in the housing so as to protrude through the aperture, the track ball being of a solid structure or a shell structure and made from a material such as aluminium, steel, or plastic, preferably plastic having an optically patterned surface allowing an optical detection of the motion of the surface and optionally having a high friction surface coating;

iii) a set of supporting elements, e.g., supporting balls, mounted within the housing and supporting the track ball thereon, the supporting elements being configured to rotate within the housing in positions in which the three centers of the three supporting elements are positioned in a plane parallel with the top wall and constituting an equilateral triangle, the equilateral triangle being coaxially aligned in relation to the aperture in the top wall; and

iv) a motion detection system including a plurality of optical motion detectors for detecting the motion of the track ball, and for generating signals representing the motion of the track ball, each of the plurality of optical motion detectors being juxtaposed relative to the track ball in positions defining an orthogonal motion detection system having its center positioned at the center of the track ball and defining three orthogonal coordinate axes, the plurality of optical motion detectors detecting the motion of the track ball in relation to the axes of the orthogonal motion detection system.

Another embodiment of the present invention includes a 3D track ball system comprising:

i) a housing defining a bottom wall and a top wall, the top wall being in spaced apart relationship above the bottom wall and defining therebetween an inner space of the housing, a substantially circular aperture of a diameter of between about 10 mm and about 70 mm, preferably approximately 40 mm, being provided in the top wall;

ii) a track ball rotatably mounted in the housing so as to protrude through the aperture, the track ball being of a solid structure or a shell structure and made from a material such as aluminium, steel, or plastic, preferably plastic optionally having a high friction surface coating providing a coefficient surface friction of between about 0.1 to 1, and defining a diameter of not less than about 100% of the diameter of the aperture in the top wall;

iii) three supporting balls rotatably mounted in the housing and supporting the track ball, said supporting balls being made of a material such as steel or plastic having a coefficient of surface friction less than the coefficient of surface friction of the track ball, and preferably of more than about 0.1, the supporting balls being mounted and journalled freely rotatably within the housing in positions in which the three centers of the three supporting balls are positioned in a plane parallel with the top wall and constituting an equilateral triangle, the equilateral triangle being coaxially aligned in relation to the aperture in the top wall, the supporting balls further being positioned having their centers positioned in relation to the center of the track ball in an orthogonal coordinate system, and including three orthogonal coordinate axes; and

iv) a motion detection system including three motion detectors for detecting the motion of a respective ball of the supporting balls along a respective axis of the orthogonal coordinate system, and for generating signals representing the motion of the supporting balls along the respective axes.

In another embodiment, the present invention includes a 3D track ball system comprising:

i) a housing defining a bottom wall and a top wall in spaced-apart relationship and defining therebetween an inner space of the housing, with an aperture being provided in the top wall;

ii) a track ball rotatably mounted in the housing so as to protrude through the aperture, the track ball being of a solid structure or a shell structure and made from a material such as aluminium, steel, or plastic, and preferably plastic having an optically-patterned surface allowing the optical detection of the motion of the surface, and optionally having a high friction surface coating;

iii) a plurality of supporting elements in the housing and supporting the track ball, the supporting elements being rotatable within the housing in positions in a plane parallel with the bottom wall and providing a stable and self-centering support for the track ball in relation to the housing; and

iv) a motion detection system including a plurality of optical motion detectors for detecting the motion of the track ball and for generating signals representing the motion of the track ball, each of the plurality of optical motion detectors being juxtaposed relative to the track ball in positions defining an orthogonal motion detection system having its center positioned at the center of the track ball, the plurality of motion detectors detecting the motion of the track ball in relation to the axes of the orthogonal motion detection system.

It is contemplated that the accurate detection of the track ball in the 3D track ball system according to the present invention is obtained through the positioning of the three motion detectors in an orthogonal coordinate system having its center at the center of the track ball, because the detection of the motion of the track ball is inherently divided into the detection of the motion of the track ball relative to the orthogonal coordinate system.

It is also contemplated that the substantially frictionless operation of the 3D track ball system according to the present invention is provided through two main features, namely, (1) the particular adaptation of the surface coefficients of friction of the track ball and the supporting balls, as the track ball has a higher coefficient of surface friction than the supporting balls; and (2) the geometrical structure established with the three supporting balls positioned in an orthogonal coordinate system in which the center of the orthogonal coordinate system is located at the center of the tracking ball. According to the positioning of the centers of the supporting balls in the above described orthogonal coordinate system, the points of contact between the track ball and the three supporting balls are also located in the same orthogonal coordinate system, as the points of contact between the supporting balls and the track ball are located on the axes of the orthogonal coordinate system.

Further, the detectors included in the 3D track ball systems are for providing a maximum elimination of cross talk between the 3D motion detection system arranged in an orthogonal coordinate system providing a maximum spacing between the three detectors. This compares favorably to conventional 3D track ball systems in which the motion detectors for generating signals representing the motion of the track ball in the 3D space are positioned close to one another, giving rise to a detection of the motion of the track ball that is not entirely satisfactory with respect to high resolution and elimination of cross talk between the three channels corresponding to the three detectors and representing the 3D motion in the 3D display system.

According to alternative embodiments of the 3D track ball system according to the present invention, the three optical motion detectors may be adapted to detect the motion of the track ball along a respective coordinate axis of the orthogonal detection system. Alternatively, the motion detection system may comprise optical detectors, each detecting the motion of the surface of the track ball relative to the individual optical motion detector. Thus, according to the first alternative embodiment, the motion of the track ball is through the uniaxial detection of each of the three optical motion detectors divided into a detection by each of the optical motion detectors along a respective coordinate axis of the orthogonal motion detection system, while according to the second alternative embodiment, the individual optical motion detectors preferably include optical motion detection sensors (preferably CCD detectors or sensors), or any other video detection devices.

Preferably, the track ball of the 3D track ball system is a track ball having a large outer diameter, allowing the track ball to be freely accessible by the user operating the track ball system with the palm of the user's hand. The major part of the track ball of the track ball system according to the present invention is thus freely exposed and accessible, since the major part of the track ball is positioned freely above the housing of the 3D track ball system.

According to alternative embodiments of the 3D track ball system according to the present invention, the supporting elements comprise three supporting elements preferably positioned so as to define an equilateral triangle, or four supporting elements positioned so as to define a square, or generally N supporting elements positioned so as to define an equilateral and N polygonal configuration.

Alternatively, the 3D track ball system according to the present invention may be implemented by means of rotatable balls as the supporting elements. Specifically, the supporting elements may be rotatable balls mounted and journalled freely rotatably in ball supporting bearings within the housing.

The motion detection of the 3D track ball system according to the present invention may be implemented in accordance with basically two concepts. In the first concept, the optical detectors of the motion detection system are positioned in an orthogonal co-ordinate system as the plurality of optical detectors preferably comprise three optical detectors having their centers positioned at a respective co-ordinate axis of the three-dimensional orthogonal motion detection system for detecting the motion of the track ball along a respective co-ordinate axis of the orthogonal motion detection system. In the second concept, the plurality of optical detectors comprise two pairs of optical motion detectors, each pair of the motion detectors comprising two optical detectors for the detection of the motion of the surface of the track ball relative to a two-dimensional orthogonal detection system defined by the two optical motion detectors of the respective pair of optical motion detectors. According to the second concept, the pair of optical detectors is preferably positioned at an angle of spacing of about 90 degrees. Through the provision of two pairs of motion detectors, each comprising two optical detectors, the 3D track ball system according to the present invention may readily be a simple switching operation which may be performed internally within the 3D track ball system according to the present invention or alternatively and preferably through the software of the PC to which the 3D track ball system is connected. Motion detection may be shifted between the three-dimensional mode according to the present invention and an alternative two-dimensional and conventional mode by simply utilizing the one pair of optical detectors exclusively for detecting the rotation of the track ball of the 3D track ball system relative to the one 2D co-ordinate system representing the supporting surface on which the 3D track ball system is mounted.

The presence of two pairs of motion detectors each detecting the motion of the surface of a track ball relative to a 2D co-ordinate system defined by the two optical detectors of the pair of optical detectors allows the two sets of co-ordinates relative to the two 2D co-ordinate systems to be processed internally within a 3D track ball system or alternatively within the PC to which the 3D track ball system is connected for combining the two sets of 2D co-ordinates of the two 2D co-ordinate system being spaced angularly about 90 degrees into any appropriate three-dimensional representing coordinates such as an XYZ co-ordinate system, spherical coordinate system or any other three-dimensional coordinate system.

For obtaining maximum information from the two sets of 2D coordinates produced by the two pairs of optical detectors, the data, i.e. the coordinates represented by the output signals from the optical detectors should include maximum information and, consequently, the two pairs of co-ordinate axes of the two 2D coordinate systems represented by the two pairs of optical detectors do not have any co-ordinate axes coinciding. Advantageously and preferably, the two co-ordinate systems are positioned in an orthogonal set-up in which the angles between the co-ordinate axes of the systems provide maximum information and readily process the motion or rotation of the track ball relative to the orthogonal detection system being a three-dimensional motion detection system.

The individual optical motion detector detecting the motion of the surface of the track ball is preferably constituted by optical motion detection sensors, which are preferably CCD detectors or sensors or any other video detector devices. The optical motion detectors are configured to detect the motion of the adjacent surface relative to the individual detector. The individual optical motion detector must fulfill certain requirements, as the surface of the track ball may on the one hand constitute a rough or rugged surface or on the other hand constitute a smooth surface having a printed or otherwise produced pattern providing the adequate variation of the surface allowing the optical detectors to detect the motion of the surface relative to the individual detectors. If a patterned or a rough surface is provided, the surface defines an optically detectable variation by the roughness of the surface or alternatively the pattern, as any two peaks or pattern variations are spaced apart at a minimum distance of about 0.1 mm and a maximum distance of about 2 mm. The surface or pattern variation may include color variations, shading variations, texture variations, etc.

According to the preferred embodiment, the 3D track ball system may include a microprocessor for processing the output signals generated by the optical motion detectors, and for transforming the detector output signals into a matrix representation of the motion of the track ball. According to the microprocessor-based embodiment, the representation of the motion of the track ball is presented in a matrix. According to alternative embodiments, however, the microprocessor may perform other relevant signal processing or signal transformation for presenting the track ball motion information, data, or signals in the relevant representation, such as a representation referring to the orthogonal motion detection system itself, a spherical coordinate system, or any other relevant reference.

According to the preferred embodiment of the 3D track ball system, the diameter of the circular aperture is between about 10 mm and about 70 mm, and preferably about 40 mm. The coefficient of surface friction of the track ball is in the range of about 0.1 to about 1.0, preferably about 0.1 to about 0.5, and more preferably about 0.4 to about 0.5.

According to a first alternative embodiment of the 3D track ball system, the diameter of the track ball is smaller than the diameter of the aperture of the top wall of the housing for encasing the track ball within the housing of the 3D track ball system. According to a second embodiment of the invention, the diameter of the track ball is no less than 100% of the diameter of the aperture in the top wall, and may be between about 100% and about 200%, and preferably between about 120% and about 150% of the diameter of the aperture.

According to the above-described first alternative embodiment of the configuration of the 3D track ball system, in which the track ball is encased within the housing of the 3D track ball system, the three supporting balls preferably define an equilateral triangle having a side length that is no more than the square root of 3 times the radius of the track ball in order to ensure that the track ball is properly journalled and arrested by the three supporting balls within the housing of the 3D track ball system.

The supporting balls provide the substantially frictionless journalling of the track ball of the 3D track ball system according to the present invention. The supporting balls are preferably made of a material, such as steel or plastic, having a coefficient of surface friction that is less than that of the track ball, and preferably of more than about 0.1. Specifically, the coefficient of surface friction of the supporting balls may be in the range of about 0.1 to about 0.9, preferably about 0.1 to about 0.4, and more preferably about 0.2. Furthermore, each of the supporting balls has a diameter of between about 8 mm and about 20 mm. It is believed that the provision of the supporting balls having diameters in the above range contributes to the provision of the above-described substantially frictionless journalling of the track ball in the 3D track ball system. In this context, it is preferred that the track ball is made from ABS, POM, PE, or PP, optionally with a solid core, and preferably having an outer rubber surface coating, such as a natural rubber surface coating or silicone rubber surface coating.

According to another embodiment of the 3D track ball system according to the present invention, the motion detection system includes separate motion transmission rollers for the transmission of the motion of a respective ball of the three supporting balls to a motion detector for the detection of a signal representing the motion of the respective ball along its respective axis of said orthogonal coordinate system. Although this embodiment of the 3D track ball includes a set of motion transmission rollers including three motion transmission rollers, the present invention is by no means limited to the above embodiment as the detection system may be implemented without the provision of the motion transmission rollers, or it may be implemented including different kinds of motion transmission elements such as motion transmission balls, motion transmission belts, etc.

For the rollers of the above described transmission roller system included in the above described presently preferred embodiment of the 3D track ball system according to the present invention, it is preferred that the rollers have a coefficient of surface friction higher than the coefficient of surface friction of each of the supporting balls of the set of three supporting balls. The rollers also preferably have a coefficient of surface friction substantially equal to the coefficient of surface friction of the track ball. Through the provision of the rollers, each having a coefficient of surface friction higher than the coefficient of surface friction of each of the supporting balls and preferably equal to the coefficient of surface friction of the track ball, the above described frictionless journalling of the track ball of the 3D track ball system according to the present invention is further improved and refined.

For providing a maximum sensitivity of the motion detection system, it is preferred that the rollers of the three motion transmission rollers have an outer diameter smaller than the outer diameter of each of the supporting balls of the set of three supporting balls, with an outer diameter of the order of about 1 mm to about 10 mm. As will be readily understood, the smaller diameter of each of the rollers as compared to the outer diameter of each of the supporting balls provides a gear ratio between the supporting balls and the rollers larger than 1 and in doing so, transforms any rotational motion of a respective ball of the three supporting balls to a corresponding rotational motion in the opposite direction of the corresponding roller, but with a rotational velocity higher than the rotational velocity of the supporting ball in question.

In the above described embodiment of the 3D track ball system according to the present invention including the above described motion transmission rollers, the motion transmission rollers also preferably constitute an orthogonal system, whereby the axes of rotation of the three motion transmission rollers define themselves an orthogonal coordinate system having its center at the center of the track ball.

The 3D track ball system according to the present invention may include a motion detector system based on any conventional detector technique including optical detection, magnetic, capacitive or inductive detection or even resistive detection principles. Consequently, the motion detectors of the 3D track ball system according to the present invention may, according to alternative embodiments include an optical detector, a capacitive detector or an inductive detector. For the detection of the motion of the 3D track ball system, each of the motion detectors includes an optical detector, a capacitive detector, or an inductive detector for the detection of the motion of its respective ball along its respective axis of the orthogonal coordinate system and for generating a signal representing the position of the ball in question or alternatively the velocity of the ball in question.

In the 3D track ball system according to the present invention, the optical detector principal is preferably used for providing a highly accurate detection of the motion of the track ball. The motion detectors may include, in accordance with the one embodiment of the 3D track ball system, slotted wheels, with each of the motion detectors preferably including a slotted wheel journalled on the axis of the rotational roller and chopping the light from a light source, such as an LED, as the light path from the light source is directed to a light detector, such as a photodiode. Alternatively, the motion detectors based on the optical detector principals may include differently configured light transmission elements, such as light transmission elements based on lens systems, fiber optic elements etc., which elements or structures are well known in the art.

The motion detection may further, according to the teachings of the present invention, be improved or refined through the use of two LEDs or a single LED having a pair of fiber optic elements defining an optical structure similar to the structure, including two separate LED's for each of the motion detectors. The provision of two LEDs for each motion detector allows for the detection of and discrimination between the transmission and the non-transmission of light through a slot of the slotted wheel, while the transmission of light from the other LED is interrupted by the slotted wheel. The LEDs are preferably IR LEDs, and the photo diode preferably is an IR sensitive photo diode. In greater detail, each of the motion detectors preferably includes two LED's, one for the transmission of light through a slot of the slotted wheel, while the transmission of light from the other LED is interrupted.

The processing of the signals generated by the photo diode of the motion detectors may be based on any relevant signal processing technique, including filtering, amplification, AD or DA conversion, etc. Irrespective of the actual technique of processing the signals generated by the three photo diodes of the motion detectors of the 3D track ball system according to the present invention, Schmitt triggers are preferably included for the shaping of the pulses detected by the photo detector diodes, allowing the signal processing to be carried out based on high slope pulses generated by the Schmitt triggers.

The above objects, advantages, and features, together with numerous other objects, features and advantages will be evident from the detailed description of the invention. Of course, it is to be understood that not necessarily all such objects, advantages, and features will be embodied in any particular embodiment of the present invention.

### BRIEF DESCRIPTION OF THE DRAWINGS

A general 3D track ball system that implements the various features of the present invention will now be described with reference to the drawings. The drawings and the associated descriptions are provided to illustrate embodiments of the present invention and not to limit the scope of the present invention. Throughout the drawings, reference numbers are re-used to indicate correspondence between referenced elements.

FIG. 1 is a schematic view of a supporting ball and a cup according to a first embodiment of the present invention;

FIG. 2 is a schematic view of a track ball positioned on three supporting balls, which constitute an orthogonal support system and an orthogonal detector system;

FIG. 3 is a perspective view of the track ball and the three supporting balls of FIG. 2;

FIG. 4 is a schematic view illustrating the transmission of motion of the track ball to a single motion transmission track ball of the motion detection system;

FIG. 5 is a schematic view illustrating the transmission of motion of the track ball by means of the motion transmission balls;

FIG. 6 is an overall diagrammatic view of the electronic circuitry of the motion detection system of the 3D track ball system according to the first embodiment of the present invention;

FIG. 7 is an overall schematic and perspective view of the 3D track ball system according to the first embodiment of the present invention;

FIGS. 8a, 8b, and 8c are overall schematic and perspective views of a second embodiment of the 3D trackball system according to the present invention;

FIG. 9 is an overall diagrammatic view of the electronic circuitry of the motion detector system of the second embodiment of the 3D track ball system shown in FIGS. 8a, 8b, and 8c;

FIGS. 10a and 10b are a side elevational view and an end view, respectively, of a 3D track ball system in accordance with a third embodiment of the present invention;

FIGS. 11a and 11b are a vertical sectional view and a top view, respectively, of the embodiment of FIGS. 10a and 10b;

FIGS. 12a and 12b are a perspective view and a disassembled view, respectively, of the embodiment of FIGS. 10a and 10b;

FIGS. 13a, 13b, and 13c are a partial sectional view, a top view, and an exploded perspective view, respectively, of the track ball supporting cup of the embodiment of FIGS. 10a and 10b;

FIG. 14 is a diagrammatic view illustrating the orthogonal detection principle of the 3D track ball system of the present invention;

FIG. 15 is a schematic view of the electronic circuitry of one of the detectors of the third embodiment of the present invention of FIGS. 10a and 10b; and

FIG. 16 is a schematic view of the electronic circuitry of the motherboard used in the third embodiment of the present invention.

### DETAILED DESCRIPTION OF THE INVENTION

The present invention has applicability in the field of track balls in general. For illustrative purposes, however, the following description pertains to 3D track ball systems. In particular, the 3D track ball system may be described in terms of a wired embodiment using a 3D detection system. The 3D track ball system can be readily adapted for use in a 2D track ball system because the 3D detection system allows monitoring of the motion of the track ball in a 2D coordinate system. For example, an optical detector positioned at the bottom of the 3D track ball system may be used in the 2D track ball operational mode for the detection of the motion of the supporting surface relative to the 3D track ball system. In another example, the 2D track ball operational mode may be established through a mechanical device, such as a rotatable ball, the motion of which is detected by a mechanical detector such as a potentiometer, a proximity detector, a capacitive detector, etc. Furthermore, the 3D track ball system may be readily modified into a wireless or cordless 3D track ball system or mouse, in accordance with conventional wireless transmission techniques.

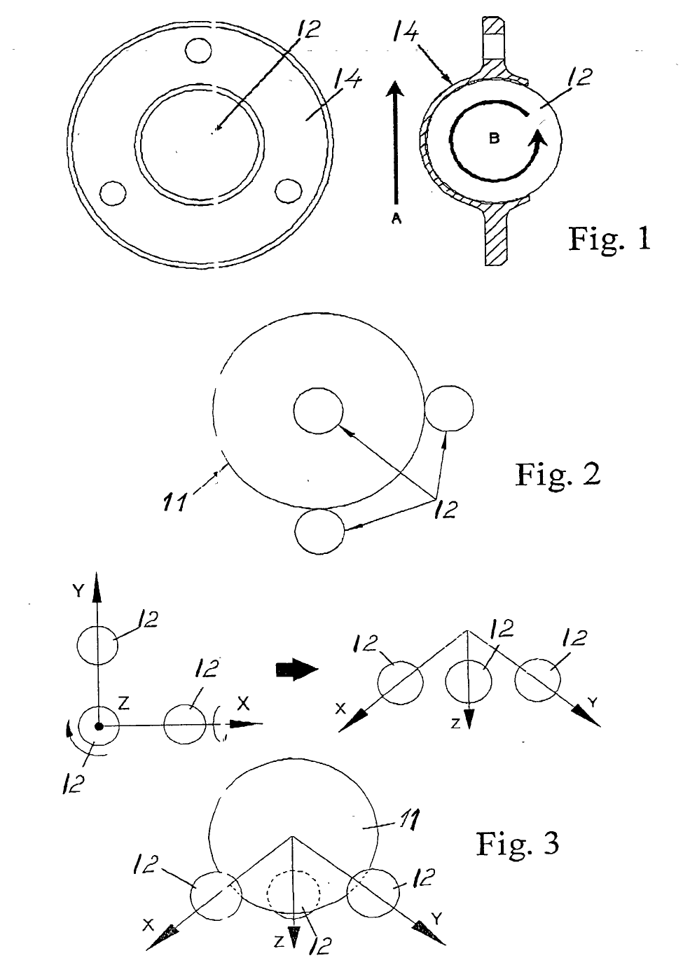

FIGS. 1-7 show a 3D track ball system according to a first embodiment of the present invention. Referring to FIGS. 1, 2, 5 and 7, the 3D track ball system 10 includes an operating ball or track ball 11, supporting balls or elements 12, and sensors 13. Preferably, the 3D track ball system 10 includes one track ball 11, three supporting balls 12, and three sensors 13. In addition, the 3D track ball system 10 might include a cup 14.

The track ball 11 has an ergonomic, comfortable and attractive design. The size, shape, dimension, material, and structure of the track ball 11 may be selected to achieve the ergonomic, comfortable and attractive design. For example, the diameter of the track ball 11 is preferably between about 40 mm and about 150 mm, and the track ball 11 is preferably made of a soft plastic material having a relatively high coefficient of surface friction.

Referring to FIG. 1, a portion of the 3D track ball system is shown with the supporting ball 12 positioned in the cup 14. Each cup 14 provides three degrees of freedom for its respective supporting ball 12. Consequently, each of the supporting balls 12 can rotate without the supporting ball 12 moving in any direction deviating from rotational motion. Each supporting ball 12 may be held in the cup 14, which keeps the supporting balls correctly positioned relative to the track ball 11. A top view of the 3D track ball system shows that the supporting balls 12 are arranged along a circle with about 120 degrees between them. In one embodiment, four supporting balls 12 are arranged along a circle with about 90 degrees between them. In addition, each supporting ball 12 defines an angle of 45 degrees to a base (see FIG. 7). The supporting balls 12 and the cups 14 are made of a material having a desirable coefficient of surface friction. For example, the surface friction between the track ball 11 and the supporting balls 12, between the supporting balls 12 and the sensors 13, and between the supporting balls 12 and the cups 14 is optimal.

Referring to FIGS. 2 and 3, the three supporting balls 12 are positioned to interpret the movement of the track ball 11 in three dimensions. To accomplish this, each supporting ball 12 is positioned so that its individual central axis extends through the center point of the track ball 11. In addition, the supporting balls 12 are placed in an orthogonal detection system in which the central axis of each of the supporting balls 12 defines an angle of 90 degrees with the central axis of each of the other supporting balls 12. To further explain this concept, considering the track ball 11 as a 3D coordinate system in which the center of the coordinate system is positioned in the center of the track ball 11. At the points where the three coordinate axes intersect the outer surface or sphere of the track ball 11, the supporting balls 12 are positioned so that their individual central axes are co-linear with their respective coordinate axes.

As shown in FIG. 2, the track ball 11 is placed freely on top of the three-supporting balls 12. The supporting balls 12 are levelled during set-up, and due to gravity, the track ball 11 is supported equally by the supporting balls 12. The levelling of the supporting balls 12 is performed by rotating the 3D coordinate system with the intersection of the graphic axes placed in the middle of the track ball 11, 45 degrees around two of the existing axes. FIG. 3 illustrates how the supporting balls 12 are positioned relative to the track ball 11. At approximately the same time, the coordinate system is rotated around the X- and Z-axes. This arrangement of the supporting balls 12 results in the track ball 11 being covered less than 50%. This allows the user to have a larger working surface which will make the track ball system easier to use and control.

Referring now to FIG. 5, each sensor 13 is positioned adjacent to the supporting ball 12 to accurately measure the motion of the track ball 11. For example, the sensors 13 are positioned for providing the correct transformation of the motion of the track ball 11 into three motion components defined by the axes of the motion detection. The supporting balls 12 are positioned to minimize the resistance between the track ball 11 and the supporting balls 12. This is accomplished by, for example, preventing each supporting ball 12 from rotating in the longitudinal direction of its respective sensor 13.

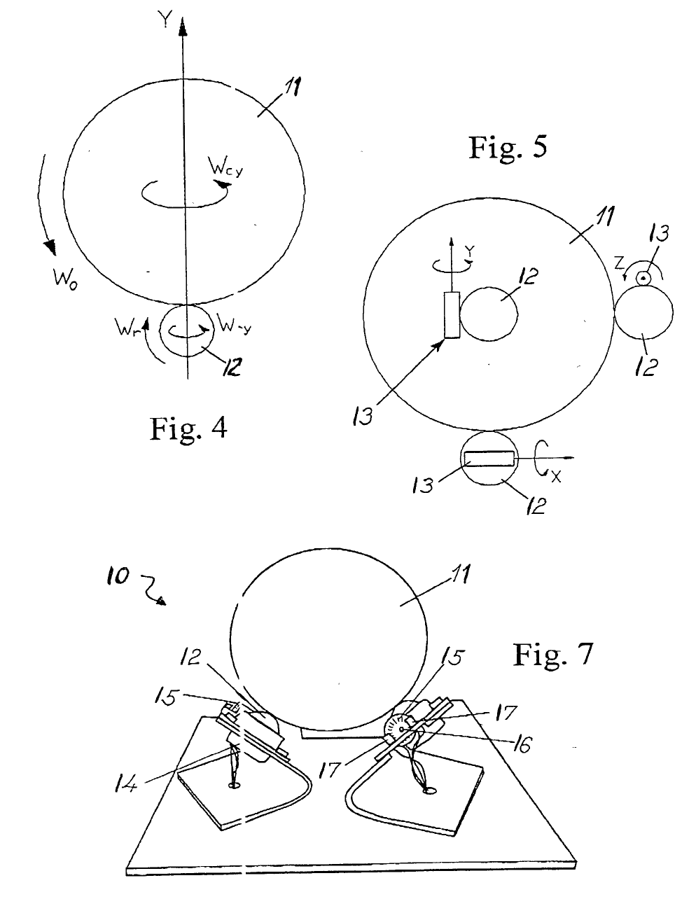

Each supporting ball 12 moves during the rotation of the track ball 11 around two axes, as shown in FIG. 4. The third axis of movement is aligned with one of the spinning axes of one of the sensors 13, and there is generally little to no movement transferred because there is usually only one contact point between the two objects, namely, the supporting balls 12 and the sensors 13. Once the sensors 13 are positioned correctly, the same or similar situation will result between the sensors 13 and the supporting balls 12, except that the supporting balls 12 will rotate around two contact points and will affect the sensor 13 around one contact point, as shown in FIGS. 4 and 5.

A clockwise rotation of the track ball 11 around the Z-axis results in a counter clockwise rotation around the Z-axis of the supporting ball 12 that is placed beneath the track ball 11. Even though the supporting ball 12 is able to rotate, the sensor 13 contacting the supporting ball 12 may be unable to rotate because the supporting ball 12 is rotating around an axis going through its own center and the contact point between the supporting ball 12 and the sensor 13. The sensor 13 typically has a surface with a higher coefficient of friction, such as, for example, a rubber surface, which enhances the movement of the supporting ball 12 and the sensor 13.

Referring to FIGS. 2, 3 and 5, the track ball 11 is placed on the three supporting balls 12, which are used to support the track ball 11. Each supporting ball 12 is positioned in direct contact with the sensor 13, and is further positioned in an orthogonal detection system in which each of the three sensors 13 detects the motion of its respective supporting ball 12 along one of the three axes of the orthogonal detection system. Every movement of the track ball 11 affects the supporting balls 12 and results in a rotation of the supporting balls 12. The sensors 13 connected to the rotating supporting balls 12 measure the movement of the track ball 11. Therefore, a rotation of the track ball 11 results in a rotation of the supporting balls 12, which results in a rotation of each of the sensors 13. Every movement of the track ball 11 is detected by one or more of the three sensors 13.

Electrical Design

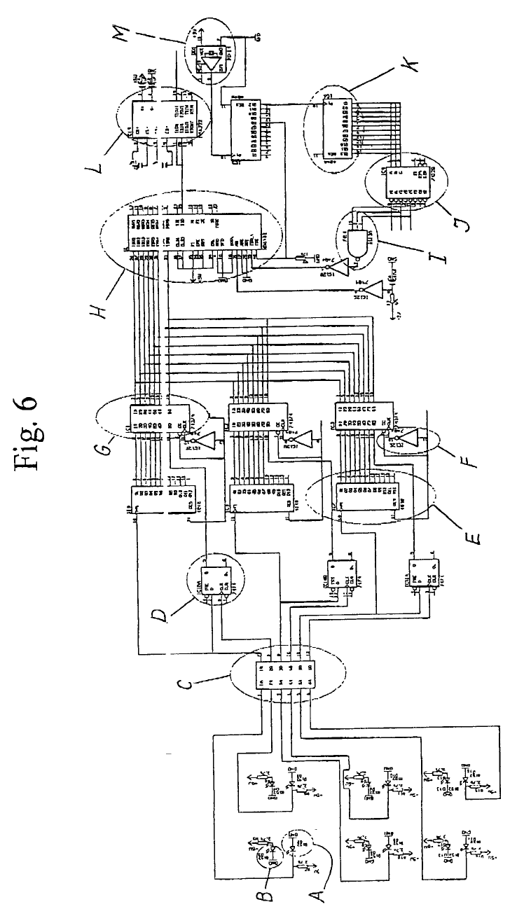

The electronics of the 3D track ball system according to the first embodiment of the present invention is shown in FIGS. 6 and 7.

Data Collection using the Sensors

As shown in FIG. 7, each sensor 13 includes a slotted wheel 15 with a shaft 16 in contact with the supporting ball 12. When the supporting ball 12 rotates, the shaft 16 rotates, which then makes the wheel 15 rotate. Each sensor 13 also includes light emitting diodes and photosensitive diodes 17. On one side of the wheel 15, two light emitting diodes (LEDs) (not shown) are mounted. The LEDs emit light through the slots of the wheel 15. On the opposite side of the wheel 15, two photosensitive diodes 17 are positioned. The diodes 17 receive light from the LEDs. When the wheel 15 rotates, the light is transmitted through the slots to the diodes 17. This causes the light to pulse. Two diodes 17 are used so that the direction of the rotation of the wheel 15 can be determined. The diodes 17 are positioned so that only one diode is detecting light at a particular instance in time. That is, if one diode 17 is detecting light, the other diode 17 is not detecting light.

Schmitt Trigger

Type 74hc14

Since the pulses generated by the photosensitive diodes 17 are soft wave shaped, the pulses are transformed into sharp-edged pulses so that the number of pulses can be more easily determined. The pulses from the sensors 13 are passed through a plurality of Schmitt triggers to generate square-wave pulses. The Schmitt triggers typically invert the signal, which generally has no effect on the measurement because only the flanks are needed for counting.

Positive Edge Flip-Flop

Type MM74hc74AN

To determine the direction of the movement of the wheel 15, a positive edge flip-flop may be used. The two pulse signals from the sensors 13 are input into the flip-flop. One pulse is used to trigger the flip-flop while the other is used for comparison. When the flip-flop receives a flank from the trigger pulse it checks the state of the other signal. If the signal is low, it returns a low signal, and if the signal is high, it returns a high signal.

Counter

Type MM74hc4040

The pulses from one of the sensors 13 are routed to a counter. The counter counts the number pulses it receives. The counter has 12-bit accuracy, but only 7 bits of the 12 bits are used. This allows a total of 128 pulses to be counted. The counter is reset after each sample so the 128 counts are sufficient.

Latch

Type MM74hc374N

The latch collects the 7 bits from the counter and the direction bit from the flip-flop. The collection is performed once per sample. The function of the latch is to lock the data while they are being read by a universal asynchronous receiver-transmitter (UART) (see below), which is conventionally used in a computer for the handling of asynchronous serial communication. The latch is also used to direct the sequence in which the data from the sensors 13 are sent to the UART.

UART

Type HD6402

The UART translates the input signal from the latches into a serial signal that can be transferred to the computer. Internally, the UART has a latch to ensure that the input data are not changed while being sent. The UART is reset upon startup to clear the registers. This is done by a “power-on” signal which is generated when the circuit is turned on.

Line Driver

Type MAX232ACPE

The line driver takes the signal from the UART and ensures that it is sent in the right format.

Crystal Oscillator

Type MMx363a

A crystal oscillator generates a frequency used for timing of the circuit.

Frequency Splitters

Type MM74hc4040

The frequency generated by the crystal oscillator is too high to be used directly to time the sampling rate of the UART. Therefore, a counter is introduced as a frequency splitter. Using a counter has the benefit that several different sampling rates can be obtained. The frequency used to control the UART is, however, too high to control the sequence in which the data are sent to the UART. To correct this, another counter is introduced. The output from this counter is 12 bits, out of which 3 are selected using a patch. These 3 bits can then be used to control the sequence.

Sequencer

Type MM74hc138

The sequencer is used to control the sequence in which the data are sent to the UART. The frequency is determined using the 3 bits. Depending on the bit pattern input into the sequencer, the sequencer will choose which data to send.

The signal from the sequencer is used to:

(1) Signal the UART to send the data. The signal is collected through a NAND gate.

(2) Signal a specific latch to collect its data or become transparent.

(3) Reset a specific counter.

The sequencer points to eight registers, of which only three are used. This provides a short time delay, which enables the detection of the start of the sequence.

Driver Software

Input to the driver software is sent from the orientation device through a serial port. The input includes one byte per sensor 13, sequentially divided with one byte per sample.

The serial port is read with the function READFILE. This function has an internal buffer to insure that there is no loss of data even if the system is busy when the data arrive. The output from the function is the counted pulses from a specific sensor 13.

The pulses from the three sensors 13 are then translated into angles around the three local axes (x′, y′, z′) of the sensors 13. This is accomplished by multiplying the pulses by a correction factor. These angles are then translated into angles around the global axes (x, y, z). This is accomplished by rotation of the local coordinate system to align with the global coordinate system, with a 4 by 4 matrix multiplication.

Viewer Software

The viewer software is based on a “Direct3D” example program from Microsoft. The program allows the user to rotate a 3D object using the orientation device.

Below is a list of electrical and electronic components that are illustrated in FIG. 6 and are used in the 3D track ball system shown in FIGS. 1-7.

| | Component name | No. Of | Letter on |
|---|---|---|---|
| Component | on drawing | Components | drawing |
| Photo Diode B152 | D7, D8, D9, D10, | 6 | A |
| | D14, D15 | | |
| Light Emitting Diode B152 | D3, D4, D5, D6, | 6 | B |
| | D12, D13 | | |
| Resistance 2.7 KΩ | R4-R15 | 12 | |
| Schmitt Trigger 74hc14 | | 1 | C |
| Positive Edge Flip-Flop | IC10A, IC10B, | 3 | D |
| MM74hc74AN | IC11A | | |
| Counter MM74hc4040 | IC7, IC8, IC9 | 3 | E |
| Inverter 7410 | IC12A-F | 5 | F |
| Latch MM74hc374N | IC1, IC2, IC3 | 3 | G |
| UART HD6402 | U1 | 1 | H |
| NAND Gate 7010 | IC13A | 1 | I |
| Resistance 47 KΩ | R3 | 1 | |
| Resistance 12 KΩ | R2 | 1 | |
| Capacitor C47 μF | C6 | 1 | |
| Sequencer MM74hc138 | IC4 | 1 | J |
| Frequency Splitter | IC5,IC6 | 2 | K |
| MM74hc4040 | | | |
| Line Driver MAX232ACPE | IC14 | 1 | L |
| Capacitor C1 μF | C1, C4, C3, C2 | 4 | |
| Crystal Oscillator | QG1 | 1 | M |
| MMx363a | | | |

Element Description of the 3D Track Ball System:

The 3D track ball system of the present invention may include the following 21 elements.

| | |
|---|---|
| 1 track ball | The diameter of the track ball is about |
| | 100 mm and track ball is made of a hard Nylon |
| | core covered with a 4 mm thick layer of natural |
| | rubber/Silicon rubber. |
| 3 supporting balls | The diameter of the three supporting balls is about |
| | 20 mm and the three supporting balls are made of |
| | ball bearing steel made by SKF/TRAFALGAR |
| | BEARING CO. |
| 3 cups or bearings for | The cups are made to hold the supporting balls in |
| the supporting balls | place and are milled out in POM. |
| 3 tracing wheels | The sensing wheels are cast in ABS. |
| (slotted wheels) | |
| 6 monitoring or | Each of the monitoring systems include one |
| reading systems | photodiode and one light emitting diode. |
| 1 fixture plate | The fixture plate is made of a 2 mm thick steel |
| | plate. |
| 3 mounting clamps | The mounting clamps are cut and bent out from a |
| | 2 mm thick steel plate. |
| 1 cover box | The cover box is cast in SB and has a size that |
| | makes it possible for it to contain the electronics |
| | and to place the mechanical parts on top of it. |

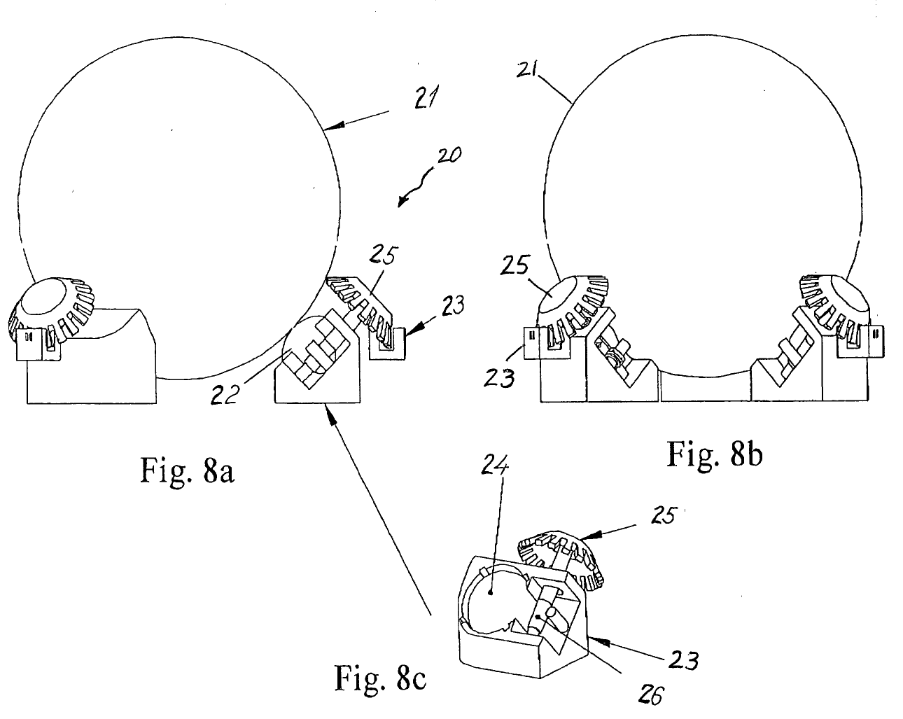

FIGS. 8a, 8b, and 8c are overall schematic and perspective views of a second embodiment of the 3D trackball system according to the present invention. present invention. The 3D track ball system 20 includes an operating ball or track ball 21, supporting elements or rollers 22, and sensors 23. Preferably, the 3D track ball system 20 includes one track ball 21, three rollers 22, and three sensors 23. In addition, the 3D track ball system 20 might include a cup 24 for holding the rollers 22.

Each sensor 23 includes a slotted wheel 25 with a shaft 26 in contact with the roller 22. When the roller 22 rotates, the shaft 26 rotates, which then makes the wheel 25 rotate. Each sensor 23 might also include light emitting diodes and photosensitive diodes. On one side of the wheel 25, two LEDs (not shown) are mounted. The LEDs emit light through the slots of the wheel 25. On the opposite side of the wheel 25, two photosensitive diodes are mounted. The diodes receive light from the LEDs. When the wheel 25 rotates, the light is transmitted through the slots to the diodes. This causes the light to pulse. Two diodes are used so that the direction of the rotation of the wheel 25 can be determined. The diodes are positioned so that only one diode is detecting light at a particular instance in time. That is, if one diode is detecting light, the other diode is not detecting light.

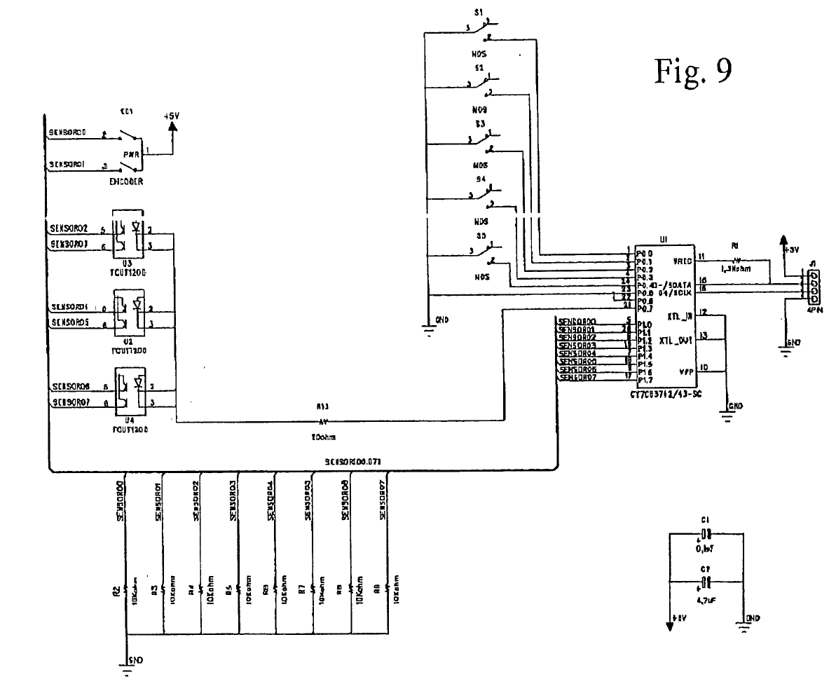

FIG. 9 is an overall diagrammatic view of the electronic circuitry of the motion detector system of the second embodiment of the 3D track ball system shown in FIGS. 8a, 8b, and 8c.

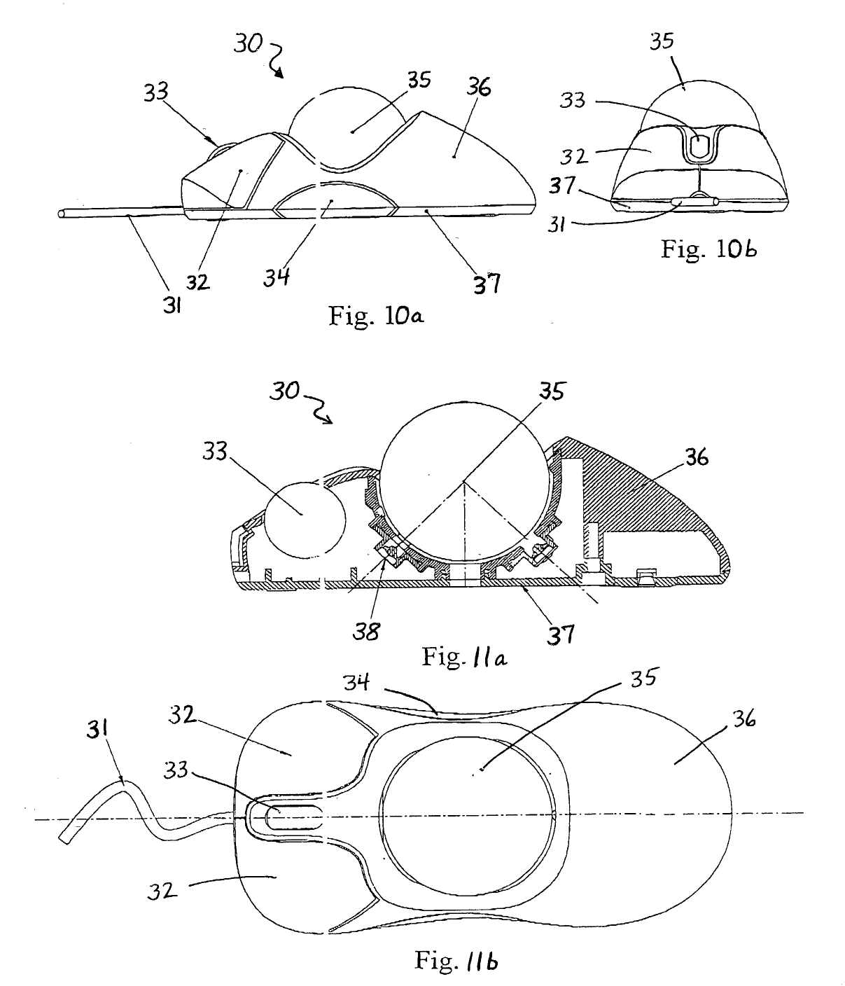

FIGS. 10a, 10b and 11b are a side elevational view, an end view, and a top view, respectively, of a 3D track ball system in accordance with a third embodiment of the present invention. The 3D track ball system 30 includes a cord or wire 31, which is connected to a CPU of a computer system, a primary button 32, a scroll wheel 33, a secondary button 34, a track ball 35, and a housing 36. The housing 36 has an aperture, which receives the track ball 35, and through which the track ball 35 protrudes. The 3D track ball system 30 further includes a base 37 for supporting the housing 36 and for mounting electronic circuitry.

The track ball 35 is positioned behind the primary button 32 and the scroll wheel 33. The secondary button 34 is positioned on one side of the track ball 35. Further, the track ball 35 is positioned above and slightly retracted relative to the secondary button 34. It is believed that the above geometric configuration of the track ball 35 relative to the primary button 32, the scroll wheel 33, and the secondary button 34 represents an optimal ergonomic structure.

Referring to FIG. 11a, a vertical sectional view of the 3D track ball system is shown, illustrating a track ball supporting cup 38 located centrally within the housing 36. The 3D track ball supporting cup 38 supports the track ball 35 and two sets of optical detectors 39. The optical detectors 39 are positioned in an orthogonal coordinate system along the X, Y, and Z coordinate axes, which has its center positioned at the center of the track ball 35.

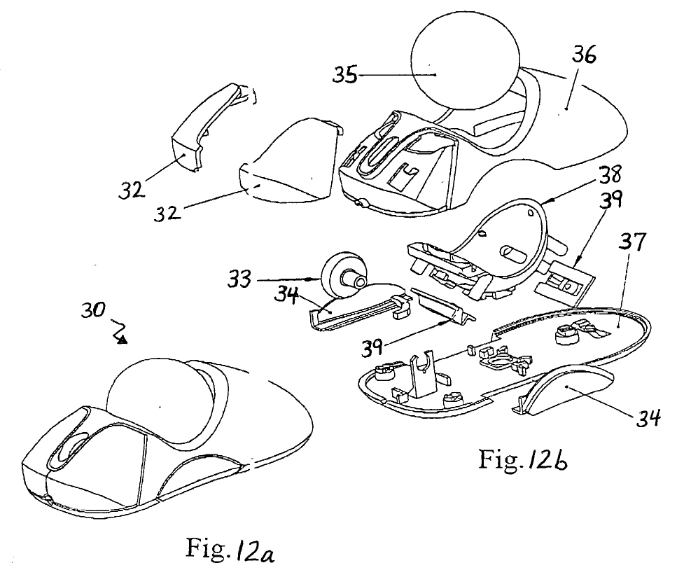

FIG. 12a is a perspective view of the 3D track ball system according to the present invention, and FIG. 12b is a disassembled view of the 3D track ball system according to the present invention. As shown in FIG. 12b, the 3D track ball system may include two primary buttons 32 and two secondary buttons 34.

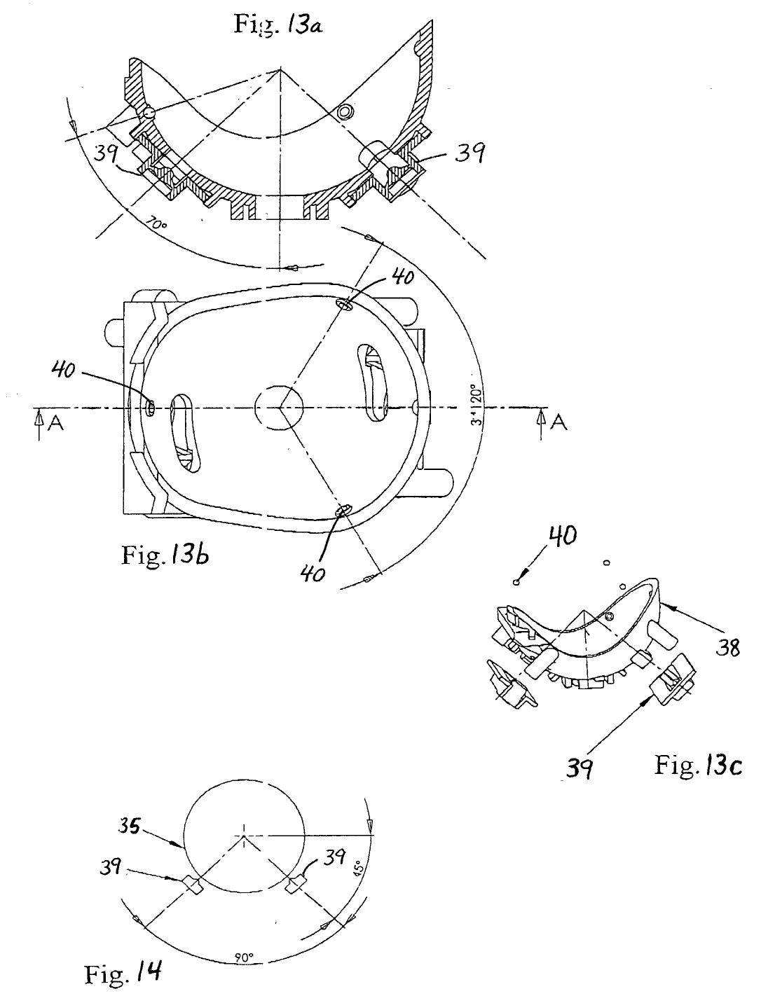

In FIGS. 13a, 13b and 13c, the cup 38, also referred to as a mounting cup or supporting cup, is illustrated in greater detail in a vertical sectional view, a top view and an exploded perspective view, respectively. A plurality of supporting balls 40 are positioned at the corners of an equilateral triangle having its plane positioned substantially parallel with the base 37 of the 3D track ball system. As is illustrated in FIG. 13a, each of the supporting balls 40 defines an angle of about 70 degrees relative to the vertical central line of the cup 38.

In FIG. 14, the orthogonal motion detection system is schematically illustrated. The angular distance between the optical detectors 39 of the orthogonal optical detection system is about 90 degrees.

FIG. 15 illustrates the electronic circuitry of one of the optical sensors 39 of the 3D track ball system according to the present invention. This electronic circuitry is implemented by the components listed in the below Table 1.

TABLE 1
List of Components - Optical

| | Part | | | | | | |
|---|---|---|---|---|---|---|---|
| Reference | Qty | Name | Value | Number | Manufacturer | Description | Package |
| CL1 | 1 | 49SMLB | 18 MHz | 49SMLB | SaRonix | Miniature | SMD |
| | | 180-20 | | 180-20 | | Quartz | |
| | | | | | | Crystal | |
| J1 | 1 | 6-HTMS | | HTMS-106-55-S-S | Samtec | 1.27 mm | |
| | | | | | | Pitch Pin | |
| | | | | | | Header | |
| U1 | 1 | ADNS-2051 | | ADNS-2051 | Agilent | Optical | DIP-16 |
| | | | | | Technologies | Mouse | |
| | | | | | | Sensor | |
| C2-3 | 2 | CERAMIC_OR1 | 0.1 uF | 2238 | Phycomp | Ceramic: | SMD:0603 |
| | | | | 786 | | 0.1 uF 16 V | |
| | | | | 15649 | | 10% X7R | |
| C4 | 1 | EL-LYT_2R2 | 2.2 uF | ECEV1H | Panasonic | Aluminium | SMD |
| | | | | A2R2SR | Electrolytic | | |
| | | | | | | Capacitor, | |
| | | | | | | Surface | |
| | | | | | | Mount | |
| C1 | 1 | EL-LYT_4R7 | 4.7 uF | UWX1H | Nichicon | Aluminium | SMD |
| | | | | 4R7CR1 | | Electrolytic | |
| | | | | GB | | Capacitor, | |
| | | | | | | Surface | |
| | | | | | | Mount | |
| R1 | 1 | SMD_R_15K | 15K | 2322 | Phycomp | SMD | SMD: 0603 |
| | | | 702 | | Resistor | | |
| | | | | 60153 | | | |

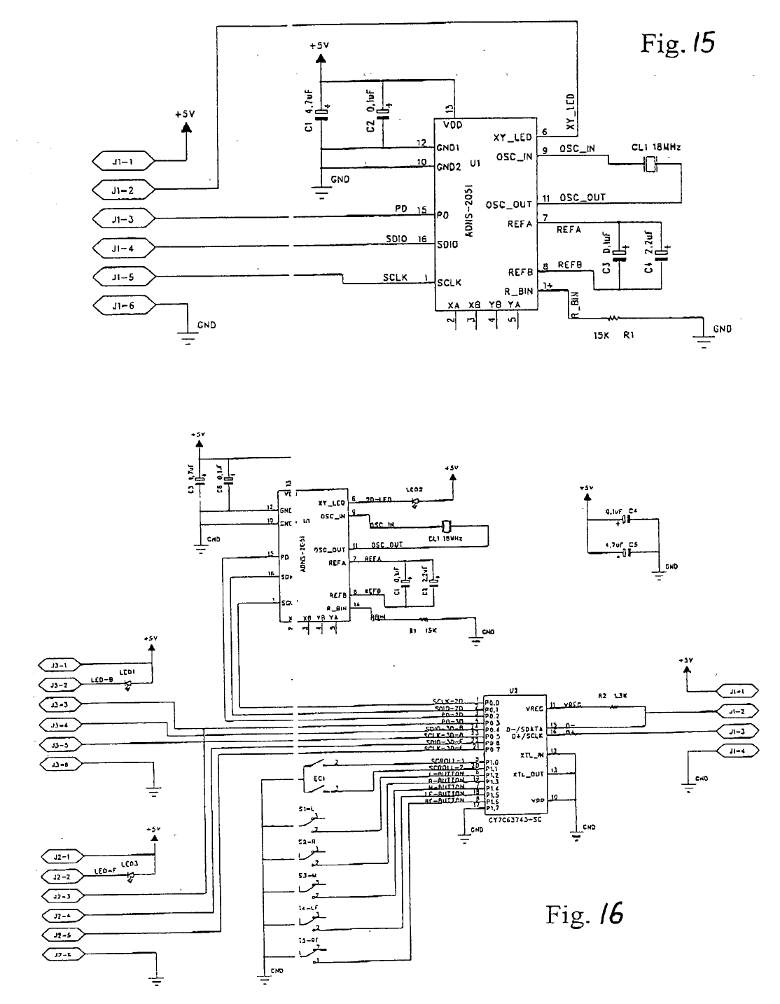

In FIG. 16, the electronic circuitry of the motherboard of the 3D track ball system according to the present invention is shown, which motherboard is implemented by means of the electronic components listed in the below Table 2.

TABLE 2
List of Components - Motherboard

| | | Part | | | | | |
|---|---|---|---|---|---|---|---|
| Reference | Qty | Name | Value | Number | Manufacturer | Description | Package |
| CL1 | 1 | 49SMLB | 18 MHz | 49SMLB | SaRonix | Miniature | SMD |
| | | 80-20 | | 180-20 | | Quartz | |
| | | | | | | Crystal | |
| J2-3 | 2 | 6-RSM | | RSM-106-02-S-S | Samtec | 6 way | |
| | | | | | | Board to | |
| | | | | | | Board SMD | |
| | | | | | | PIN | |
| | | | | | | Connector | |
| U1 | 1 | ADNS-2051 | | ADNS-2051 | Agilent | Optical | DIP-16 |
| | | | | | Technologies | Mouse | |
| | | | | | | Sensor | |
| C1 | 3 | CERAMIC_OR1 | 0.1 uF | 2238 | Phycomp | Ceramic: | SMD: 0603 |
| C4 | | | | 786 | | 0,1 uF | 16V |
| C6 | | | | 15649 | | 10% X7R | |
| U2 | 1 | CY7C637 | | CY7C63 | Cypress | Combination | SMD: 24-SOIC-S13 |
| | | 43-SC | | 743-SC | | Low- | |
| | | | | | | Speed USB & PS/2 | |
| | | | | | | Peripheral | |
| | | | | | | Controller | |
| EC1 | 1 | EC10A12 | | EC10A12 | Productwell | Incremental | LEAD |
| | | V0[3] | V0[3] | Precision | encoder 12 | | |
| | | | | | Electrics | Pulses/rotation, 24 | |
| | | | | | | dentents | |
| C2 | 1 | EL-LYT_2R2 | 2.2 uF | ECEV1H | Panasonic | Aluminium | SMD |
| | | | | | A2R2SR | | Electrolytic |
| | | | | | | Capacitor, | |
| | | | | | | Surface | |
| | | | | | | Mount | |
| C3 | 2 | EL-LYT_4R7 | 4.7 uF | UWX1H | Nichicon | Aluminium | SMD |
| C5 | | | | 4R7CR1 | Electrolytic | | |
| | | | | GB | | Capacitor, | |
| | | | | | | Surface | |
| | | | | | | Mount | |
| LED2 | 1 | HLMP-ED80 | | HLMP-ED80 | Agilent | LED Lamp | LEAD |
| | | | | | | Technologies | for Sensor- |
| | | | | | | Based | |
| | | | | | | Applications | |
| LED1 | 2 | L-934 | L-9345RCG | Kingbright | 3 mm Super | LEAD | |
| LED3 | | | | | | Bright LED | |
| | | | | | | Lamp | |
| S4-LF | 1 | MDS002 | | MDS002 | IttCannon | Micro Snap- LEAD | |
| | | | | | | acting | |
| | | | | | | Switch | |
| S5-RF | 1 | MDS003 | | MDS003 | IttCannon | Micro Snap- | LEAD |
| | | | | | | acting | |
| | | | | | | Switch | |
| R1 | 1 | SMD_R_15K | 15K | 2322 | Phycomp | SMD | SMD: 0603 |
| | | | | 702 | | Resistor 5% | |
| | | | | 60153 | | | |
| R2 | 1 | SMD_R_1K3 | 1.3K | 2322 | Phycomp | SMD | SMD: 0603 |
| | | | | 702 | | Resistor 5% | |
| | | | | 60132 | | | |
| J1 | 1 | USB-CON | | M30F60 | Harwin | 4 way SMT | SMD |
| | | | | 00406 | | PCB | |
| | | | | | | Header | |
| S1-L | 3 | ZM-CH- | | ZM-CH- | Itt Cannon | Subminiatur | LEAD |
| S2-R | | F7-PO-T | | F7-PO-T | | e Snap- | |
| S3-M | | | | | | acting | |
| | | | | | | Switch | |

According to a technique of transforming the data output from the optical sensors 39, the output signals from the 3D motion detection sensors may be transformed as follows:

First a set of linear equations is used to transform the sensor output to the screen coordinate system. The output is the detected rotation specified as three Euler angles in the screen coordinate system.

const double a=0.004569;//0.2618;

const double b=0.004166;//0.2387;

const double c=0.000255;//0.0146;

const double d=−0.002276;//−0.1304*pi/180;

const double e=0.002328;//0.1334*pi/180;

const double f=0.002206;//0.1264*pi/180;

const double g=0.002449;//0.1403;

const double h=−0.002504;//−0.1435;

const double i=0.004864;//0.2787;

eta_x=a*(double)x+b*(double)y+c*(double)z;

eta_y=d*(double)x+e*(double)y+f*(double)z;

eta_z=g*(double)x+h*(double)y+i*(double)z;

Three rotation matrices are constructed based on the Euler Angles

M3D_ROTATION_X_MATRIX<double>Mx(−eta_x);

M3D_ROTATION_Y_MATRIX<double>My(−eta_y);

M3D_ROTATION_Z_MATRIX<double>Mz(−eta_z);

M3D_{—}4×4_MATRIX<double>

g_World(XMAT[0][0],XMAT[0][1],XMAT[0][2],XMAT[0][3],

XMAT[1][0],XMAT[1][1],XMAT[1][2],XMAT[1][3],

XMAT[2][0],XMAT[2][1],XMAT[2][2],XMAT[2][3],

XMAT[3][0],XMAT[3][1],XMAT[3][2],XMAT[3][3]);

Lastly, a new view transformation matrix is constructed by multiplying the original view transformation matrix with the three rotation matrices.

g_World=g_World*Mx*My*Mz;

The 3D track ball system has been disclosed in detail in connection with various embodiments of the present invention. Although the foregoing invention has been disclosed in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. Accordingly, the present invention is not intended to be limited by the preferred embodiments, but is to be defined by reference to the appended claims.

What is claimed is:

1. A 3D track ball system comprising:
i) a housing defining a bottom wall, and a top wall, said top wall being in spaced apart relationship above said bottom wall and defining therebetween an inner space of said housing, a circular aperture being provided in said top wall;
ii) a track ball rotably mounted in the housing so as to protrude through the aperture, the track ball having a selected coefficient of surface friction and a diameter no smaller than the diameter of said aperture;
iii) a set of three supporting balls in the housing rotatably supporting said track ball thereon, said supporting balls having a coefficient of surface friction less than the coefficient of surface friction of said track ball, and being mounted and journalled to be freely rotatable within said housing in positions in which the respectve centers of the three supporting balls are positioned in a plane parallel with said top wall and constituting an equilateral triangle, said equilateral triangle being coaxially aligned in relation to said aperture in said top wall, said supporting balls further being positioned having their centers positioned in relation to the center of said tracking ball in an orthogonal coordinate system, and including three orthogonal coordinate axes; and
iv) a motion detection system including three motion detectors for detecting the motion of a respective ball of said set of three supporting balls along a respective axis of said orthogonal coordinate system, and for generating signals representing the motion of said balls along said respective axes.

2. The 3D track ball system according to claim 1, wherein the diameter of the aperture is between 10 mm and 70 mm, wherein the coefficient of surface friction of said track ball is between 0.1 and 1.0, wherein the diameter of the track ball is up to 200% of the diameter of the aperture, and wherein the supporting balls each have a diameter of between 8 mm and 20 mm.

3. The 3D track ball system according to claim 1, wherein said track ball is made from a material selected from the group consisting of aluminium, steel, and plastic, wherein the plastic is selected from the group consisting of ABS, POM, PE, and PP.

4. The 3D tack ball system according to claim 3, wherein the track ball includes a solid core and an outer rubber surface coating.

5. The 3D track ball system according to claim 1, wherein said motion detection system includes three motion transmission rollers for the transmission of the motion of a respective ball of said set of three supporting balls to a motion detector for the detection of a signal representing the motion of the respective ball along its respective axis of said orthogonal coordinate system.

6. The 3D track ball system according to claim 5, wherein each of said rollers has a coefficient of surface friction greater than the coefficient of surface friction of each of said supporting balls of said set of three supporting balls, and approximately equal to the coefficient of surface friction of said track ball.

7. The 3D track ball system according to claim 5, wherein each of said rollers of said three motion transmission rollers has an outer diameter smaller than the outer diameter of each of said balls of said set of three supporting balls, the outer diameter of each of said roller being between about 1 mm and about 10 mm.

8. The 3D track ball system according to claim 5, wherein the axes of rotation of said three motion transmission rollers define themselves in an orthogonal coordinate system having its center at the center of said track ball.

9. The 3D track ball system according to claim 1, wherein each of said motion detectors includes a detector selected from the group consisting of an optical detector, a magnetic detector, a capacitive detector, and an inductive detector, the detector providing for the detection of the motion of its respective supporting ball along its respective axis of said orthogonal coordinate system defined by said set of supporting balls, and for generating a signal representing a parameter selected from the group consisting of the position of its respective supporting ball and the velocity of its respective supporting ball.

10. The 3D track ball system according to claim 5, further comprising a light source and a light detector, and wherein each of said motion detectors includes a slotted wheel journalled on the axis of said rotational roller so as to interrupt the light from the light source as the light from the light source is directed to the light detector.

11. The 3D track ball system according to claim 10, wherein the light source comprises a first light source and a second light source, the first light source transmitting light through a slot of the slotted wheel while, and the second light source transmitting light that is interrupted by the slotted wheel.

12. The 3D track ball system according to claim 11, wherein the first and second light sources are LEDs.

13. The 3D track ball system according to claim 12, wherein the LEDs are IR LEDs, and wherein the light detector includes an IR-sensitive photodiode.

14. The 3D track ball system according to claim 10, further including Schmitt triggers for the shaping of the pulses detected by the light detectors.

15. A 3D track ball system, comprising:
i) a housing having a top wall with an aperture therein;
ii) a track ball rotably mounted in the hosuing so as to protrude through the aperture;
iii) a set of three supporting balls in the housing rotatably supporting the track ball, the supporting balls being mounted and journalled within the housing so as to be freely rotatable in positions in which the respective centers of the supporting balls are positioned in a plane parallel with the top wall and constituting an equilateral triangle coaxially aligned with the aperture; and
iv) a motion detection system comprising three optical motion detectors that detect the motion of the track ball, and that generate output signals representing the motion of the track ball, the motion detectors being juxtaposed relative to the track ball in positions defining an orthogonal motion detection system having its center positioned at the center of the track ball and defining three orthogonal coordinate axes, wherein the motion detectors detect the motion of the track ball along the coordinate axes of the motion detection system.

16. The 3D track ball system according to claim 15, wherein each of the optical motion detectors detects the motion of the track ball along a respective coordinate axis of the orthogonal motion detection system.

17. The 3D track ball system according to claim 15, wherein each of the optical motion detectors detects the motion of the surface of the track ball relative to that optical motion detector.

18. The 3D track ball system according to claim 17, wherein each of the optical motion detectors includes a CCD.

19. The 3D track ball system according to claim 15, further comprising a microprocessor that processes the output signals generated by the optical motion detectors, and that transforms the output signals into a matrix representation of the motion of the track ball.

20. The 3D track ball system according to claim 15, wherein the aperture is a circular aperture having a diameter of between 10 mm and 70 mm.

21. The 3D track ball system according to claim 15, wherein the track ball has a coefficient of surface friction of between about 0.1 and 1.0.

22. The 3D track ball system according to claim 15, wherein the diameter of the track ball is at least equal to the diameter of the aperture and no more than twice the diameter of the aperture.

23. The 3D track ball system according to claim 21, wherein the supporting balls have a coefficient of surface friction that is less than the coefficient of surface friction of the track ball.

24. The 3D track ball system according to claim 15, wherein each of the supporting balls has a diameter of between 8 mm and 20 mm.

25. The 3D track ball system according to claim 15, wherein the equilateral triangle defined by the three supporting balls has a side length that is less than or equal to √3 times the radius of the track ball.

26. The 3D track ball system according to claim 1, wherein the track ball is made of a material selected from the group consisting of ABS, POM, PE, and PP, and wherein the track ball includes an outer rubber surface coating.

27. A 3D track ball system comprising:
i) a housing defining a top wall and a bottom wall spaced from the top wall so as to define an inner space therebetween, said top wall being provided with an aperture;
ii) a track ball rotatably mounted in the housing so as to protrude through the aperture;
iii) a set of supporting elements in the housing and supporting said track ball, said supporting elements being rotated within said housing in positions in a plane parallel with said bottom wall and providing a stable and self-centering support of said track ball in relation to said housing; and
iv) a motion detection system including a plurality of optical motion detectors that detect the motion of said track ball and that generate output signals representing the motion of said track ball, each of said plurality of optical motion detectors being juxtaposed relative to said track ball in positions defining an orthogonal motion detection system having its center positioned at the center of said track ball, said plurality of optical motion detectors detecting the motion of said track ball in relation to axes of said orthogonal motion detection system.

28. The 3D track ball system according to claim 27, wherein the track ball has an optically patterned surface that facilitates the optical detection of the motion of the surface.

29. The 3D track ball system according to claim 27, wherein said supporting elements comprise a set of N supporting elements positioned so as to define an equilateral and N polygonal configuration.

30. The 3D track ball system according to claim 29, wherein said supporting elements comprise a set of three supporting elements positioned so as to define an equilateral triangle.

31. The 3D track ball system according to claim 29, wherein supporting elements comprise a set of four supporting elements positioned so as to define a square.

32. The 3D track ball system according to claim 27, wherein each of said supporting elements comprises a rotatable supporting ball mounted and journalled to be freely rotatable in a ball supporting bearing within said housing.

33. The 3D track ball system according to claim 27, wherein said supporting elements are integrally cast protruding elements of said housing that project into the inner space of the housing.

34. The 3D track ball system according to claim 33, wherein the protruding elements have a low friction surface coating.

35. The 3D track ball system according to claim 27, wherein each of the optical detectors has a center positioned along a respective coordinate axis of said orthogonal motion detection system so as to detect the motion of said track ball along the respective coordinate axis of said orthogonal motion detection system.

36. The 3D track ball system according to claim 27, wherein said plurality of optical detectors comprises two pairs of optical motion detectors, each of said pairs of optical motion detectors being arranged for the detection of the motion of the track ball relative to a two-dimensional orthogonal motion detection system defined by said pair of optical motion detectors.

37. The 3D track ball system according to claim 36, wherein said pairs of optical motion detectors are positioned at an angular spacing of 90°.

38. The 3D track ball system according to claim 36, wherein said two-dimensional orthogonal systems defined by said two pairs of optical detectors have no coinciding axes.

39. The 3D track ball system according to claim 27, wherein each of said optical motion detectors includes a CCD.

40. The 3D track ball system according to claim 27, further comprising a microprocessor that processes the output signals generated by said optical motion detectors and that transforms the output signals into a matrix representation of the motion of said track ball.

41. The 3D track ball system according to claim 27, wherein said aperture is a circular aperture having a diameter of between 10 mm and 70 mm.

42. The 3D track ball system according to claim 27, wherein said track ball has a coefficient of surface friction of between 0.1 and 1.0.

43. The 3D track ball system according to claim 41, wherein said track ball has a diameter at least equal to the diameter of said aperture and no greater than twice the diameter of said aperture.

44. The 3D track ball system according to claim 27, wherein said supporting elements have a coefficient of surface friction that is less than the coefficient of surface friction of said track ball.

45. The 3D track ball system according to claim 32, wherein each of said supporting balls has a diameter of between 0.5 mm and 20 mm.

46. The 3D track ball system according to claim 32, wherein said supporting balls define an equilateral triangle having a side length that is no more than approximately equal to √3 times the radius of the track ball.

47. The 3D track ball system according to claim 27, wherein the track ball is made of a material selected from the group consisting of ABS, POM, PE, and PP, and wherein the track ball includes an outer rubber surface coating.
